(19) United States
(12) Patent Application Publication
(10) Pub. No.: US 2024/0173782 A1
(43) Pub. Date: May 30, 2024

(54) METHOD FOR MACHINING AN ANNULAR GROOVE

(71) Applicant: Mahle International GmbH, Stuttgart (DE)

(72) Inventors: Cedric Dobua, Fellbach (DE); Roland Lochmann, Marbach (DE)

(21) Appl. No.: 17/791,798

(22) PCT Filed: Dec. 17, 2020
(86) PCT No.: PCT/EP2020/086809

§ 371 Date: Jul. 8, 2022

(30) Foreign Application Priority Data
Jan. 8, 2020 (DE) 10 2020 200 153.7

(51) Int. Cl. B23C 3/30

(52) U.S. Cl. CPC B23C 3/30

(57) ABSTRACT

A method for machining an annular groove, which is circumferential in a circumferential direction, on a cylindrical outer circumferential surface of a component is disclosed. The annular groove may have two lateral groove walls and a groove base transitioning into the two lateral groove walls in a respective transition region of two transition regions. The method may include contacting the groove base with a free end of a tool. The free end may include two lateral convex regions and a withdrawn region arranged therebetween. The method may further include reinforcing the annular groove such that the two transition regions of the annular groove are reinforced more strongly than a centre region of the groove base.

### CROSS-REFERENCE TO RELATED APPLICATIONS

This application claims priority to International Patent t Application No. PCT/EP2020/086809, filed on Dec. 17, 2020, and German Patent Application No. DE 10 2020 200 153.7, filed on Jan. 8, 2020, the contents of both of which are hereby incorporated by reference in their entirety.

### TECHNICAL FIELD

The present invention relates to a method for machining a circumferential annular groove in circumferential direction on a cylindrical outer circumferential surface of a component, in particular an annular groove of a piston of an internal combustion engine. Furthermore, the invention relates to a piston having an annular groove produced according to the method, and a roller-burnishing tool or a sliding friction tool for carrying out the method.

### BACKGROUND

Usually, such an annular groove, pre-pierced in a known manner, mostly by machining, e.g. by turning, has a groove base which transitions in a respective transition region into lateral groove walls.

From DE 2 007 647 A1 a method is known for producing annular grooves on a sealing skirt of a steel piston head, in which the annular groove is produced by rolling-in into the material of the sealing material. By the rolling-in of the annular groove into the sealing skirt, the material is to be able to be reinforced and thereby the service life of the annular groove is to be able to be extended.

From DE 198 15 485 C2 a piston is known for highly stressed internal combustion engines made of a ductile, plastically deformable material, with a piston crown having combustion bowl and with annular grooves for receiving piston rings, wherein the combustion bowl is reinforced by mechanical compression and the annular grooves are formed in an unreinforced manner. A surface of the uppermost annular groove facing the piston crown is smoothed here by a roller-burnishing method, whereby a surface roughness with a roughness depth Rz≤2 mm and a surface layer strengthening can be produced. Hereby, in particular the risk of a crack formation in the piston head is to be able to be reduced.

Generally, annular grooves of a piston of an internal combustion engine, receiving piston rings, are stressed by a gas pressure onto the piston rings, in addition through so-called LSPI events (Low Speed Pre-Ignition), which can lead to damage, in particular to cracks, in the groove base. Through a roller-burnishing by a roller-burnishing tool, the groove base can be smoothed and reinforced, whereby the formation of cracks can be counteracted. This is possible both on a mostly maximally stressed first annular groove in a ring carrier (usually made of a ferrous material) and also in a base material (usually aluminium), whereby in certain circumstances even the ring carrier can be economized on.

A disadvantage in the pistons known from the prior art and production methods for the annular grooves is, however, that in a roller-burnishing of the annular grooves often the wrong regions are smoothed and reinforced, whereby in particular a notch effect, negatively influencing the service life, can not be influenced.

### SUMMARY

The present invention is therefore concerned with the problem of indicating, for a method of the generic type, an improved or at least an alternative embodiment, which in particular enables an increase of the load-bearing capacity of a piston.

This problem is solved according to the invention by the subject matter of the independent claim(s). Advantageous embodiments are the subject matter of the dependent claim(s).

The present invention is based on the general idea of using an especially configured tool for machining an annular groove on a component, in particular of a piston of an internal combustion engine, which is configured in such a way that in particular regions of the annular groove which are prone to a notch effect, namely the transition regions between lateral groove walls and a groove base, in particular the centres or the most intensively curved regions of transition radii are reinforced, however a less stressed region during operation, namely a centre region of the groove base is less or even not smoothed or respectively reinforced at all. In the method according to the invention for the production of an annular groove of a piston of an internal combustion engine, the at least one annular groove is machined with the tool, which has two lateral convex regions and a withdrawn region lying therebetween at a free end in contact with the groove base and the groove walls during machining, so that during a machining of the annular groove the two transition regions between the groove base and the lateral groove walls are more strongly reinforced or respectively smoothed, than a centre region of the groove base arranged therebetween. Through the convex regions with comparatively large radii in addition to a material smoothing a material reinforcing can also be achieved, wherein additionally through the comparatively large radii in the region of the convex regions of the tool, which can be configured as a roller-burnishing- or sliding friction tool, the notch effect can be distinctly reduced in the machined concave regions in the workpiece between the groove walls and the groove base, in particular at a lower transition region owing to the gas pressure acting from above onto a piston ring, in so far as the annular groove is arranged in a piston. By the method according to the invention, the strength and smoothing can thus be increased and, simultaneously, the notch effect can be reduced, whereby the load-bearing capacity of the component can be increased, as well as its lifespan.

In an advantageous further development of the method according to the invention, a roller-burnishing tool or a sliding friction tool is used as a tool, which at its free end, coming into contact with the groove base on roller-burnishing or sliding, has two lateral convex regions and a withdrawn region lying therebetween, so that on a roller-burnishing or sliding friction of the annular groove, the two transition regions are reinforced more strongly than a centre region of the groove base. In the method according to the invention for machining an annular groove, the at least one annular groove is machined with a roller-burnishing tool or sliding friction tool which, at its free end in contact with the groove base and the groove walls on roller-burnishing or sliding friction, has two lateral convex regions and a withdrawn region lying therebetween, so that on a roller-burnishing or sliding friction of the annular groove, the two transition regions are reinforced or respectively smoothed more intensively between the groove base and the lateral groove walls than a centre region of the groove base arranged therebetween. Through the convex regions with comparatively large radii, in addition to a material smoothing also a material reinforcing can be achieved, wherein additionally through the comparatively large radii in the region of the convex regions of the roller-burnishing tool or of the sliding friction tool, the notch effect in the machined concave regions in the workpiece between the groove walls and the groove base can be distinctly reduced.

Although the present invention is directed in particular to the grooves, provided to receive piston rings, on pistons of internal combustion engines, it is not restricted to this use. The machining method according to the invention can also be used on annular grooves of other pistons, such as for instance of compressors. Furthermore, it is generally suitable for the machining of circumferential grooves in circumferential direction on cylindrical circumferential surfaces, preferably outer circumferential surfaces of components, such as for instance of snap ring grooves, e.g. on valve stems, piston pin hubs or camshafts.

Expediently, a roller-burnishing tool or a sliding friction tool is used, the convex regions of which have a radius R or R=B/2, wherein B is the width of the roller-burnishing tool or of the sliding friction tool or respectively is the thickness. By means of such large radii, the notch effect is distinctly reduced and hence the load-bearing capacity of the piston is distinctly increased. In such an embodiment, the two radii of the convex regions would transition into one another in an aligned manner at the free end of the roller-burnishing tool or of the sliding friction tool, so that in this case in this region, which constitutes the withdrawn region of the roller-burnishing tool or of the sliding friction tool, material must be removed from this roller-burnishing tool or sliding friction tool. Through the withdrawn region, which for example can have a concave shape or a bend, no or at most a smaller reinforcement or respectively smoothing occurs on roller-burnishing or sliding friction of the annular groove in the centre region of the groove base, which is positive, as it has been found that in particular in operation of a piston or respectively of an internal combustion engine a maximal application of force and reinforcement precisely does not occur in this centre region of the groove base. Through the form of the roller-burnishing tool or of the sliding friction tool with two outer convex regions and with a withdrawn region therebetween, the force is not only directed from the groove base into the groove flank in a targeted manner into the upper and lower transition region which is particularly at risk of cracking. In addition, the “two-legged” introduction of force into the workpiece over the torque balance leads to a more precisely determined force distribution between upper and lower transition region than would be the case with a single convex tool. Thus e.g. through central radial force introduction for instance the equal reinforcement of the upper and lower transition region can be achieved, whereas an eccentric or oblique force introduction into the groove leads to unequal contact pressing forces. This can be desirable, in order e.g. to harden more intensively the lower transition region on the groove base, stressed by the gas pressure, than the upper one. An asymmetrical reinforcement of the two transition regions (e.g. lower reinforced more strongly than upper) can be achieved, apart from through a correspondingly inclined or eccentrically displaced line of action of the introduced force, also through an asymmetrical shape of the roller-burnishing tool or of the sliding friction tool or of the cross-section of the pre-pierced groove.

In a further advantageous embodiment of the solution according to the invention, a roller-burnishing tool or a sliding friction tool with a bone-shaped or with a camel's hump-shaped free end is used. Both of these named embodiments enable the carrying out of the method according to the invention, in which the respective transition regions are reinforced or respectively smoothed more intensively between the groove base and the lateral groove walls than a centre region of the groove base. The two humps or the camel's hump-shaped free end constitute here the two lateral convex regions.

In a further advantageous embodiment of the solution according to the invention, on roller-burnishing or sliding friction of the annular groove, material is displaced from the transition regions into the centre region, so that the groove base in the centre region after the roller-burnishing or after the sliding friction projects further into the annular groove than before the roller-burnishing or the sliding friction. This constitutes a possible embodiment of the method according to the invention, in which the reinforcement or respectively smoothing of the two lateral transition regions leads to the centre region not being reinforced or respectively being reinforced much less or even being pressed out from the transition regions in the opposite direction through laterally displaced material.

Expediently, in the method according to the invention, a roller-burnishing tool or a sliding friction tool is used, the cross-section of which increases towards the free end. In this case, therefore, the cross-section narrows outwards, starting from the free end, whereby in particular rectangular annular grooves can be machined more easily.

For inserting the tool into a rectangular groove, it is particularly advantageous when the free end is formed by a non-rotating tool which smooths the groove base under a contact pressure, not in a rolling manner but under sliding friction. This machining is similar to shaving, but is carried out by an intensively negative cutting angle at a blunt free end, that metal cutting occurs scarcely or not at all, but rather a similar plastic deformation of the groove base region occurs as with roller-burnishing.

In the case of trapezoidal annular grooves, the width of which reduces with increasing depth, this is not necessary, because also a rotationally symmetrical tool can be easily inserted up to the groove base. Rectangular annular grooves, but also other annular grooves, can for example be introduced into the piston before roller-burnishing by means of a metal-cutting method, for example by means of turning, or by means of grinding. Through the outwardly narrowing cross-section of the roller-burnishing tool, an inclining thereof on roller-burnishing with respect to a radial axis of the piston is possible, whereby a distinctly improved machining of the transition regions between the lateral groove walls and the groove base is made possible.

In a further advantageous embodiment of the method according to the invention, a roller-burnishing tool or a sliding friction tool is used, the withdrawn region of which has a bend or is configured in a concave manner. A concave configuration in particular makes possible here a bend-free centre region of the groove base after the roller-burnishing or the sliding friction, whereby a notch effect can be reduced. Such a withdrawn region, configured in a concave manner, can be produced for example by a metal-cutting or grinding method on the roller-burnishing tool or sliding friction tool. When the roller-burnishing tool or the sliding friction tool has a bend for example in the withdrawn region, this withdrawn region can be easily pressed into the roller-burnishing tool or sliding friction tool by a corresponding and oppositely shaped second roller-burnishing tool or sliding friction tool.

The present invention further relates to the general idea of indicating a piston having at least one annular groove for receiving a piston ring, wherein the at least one annular groove is produced by the previously described method. Owing to the reinforced and smoothed transition regions and the simultaneously reduced notch effect, such a piston has a higher loading capacity, which has a positive effect on the lifespan of the piston according to the invention. The annular groove itself can lie here in the piston itself, for example in an aluminium or steel piston, or in a ring carrier provided for this, which is embedded into the piston.

The present invention is further based on the general idea of indicating a roller-burnishing tool or sliding friction tool for carrying out the previously described method, which has at its free end two lateral, convex regions and a withdrawn region lying therebetween. By means of such a roller-burnishing tool or sliding friction tool according to the invention, the method according to the invention can be carried out in a high-quality and, at the same time, economical manner. The withdrawn region can be introduced here into the free end of the roller-burnishing tool or sliding friction tool for example by means of machine-cutting methods or by means of grinding.

Further important features and advantages of the invention will emerge from the subclaims, from the drawings and from the associated figure description with the aid of the drawings.

It shall be understood that the features mentioned above and to be explained further below are able to be used not only in the respectively indicated combination, but also in other combinations or in isolation, without departing from the scope of the present invention.

Preferred example embodiments of the invention are illustrated in the drawings and are explained more closely in the following description, wherein the same reference numbers relate to identical or similar or functionally identical components.

### BRIEF DESCRIPTION OF THE DRAWINGS

There are shown here, respectively schematically,

FIG. 1 shows a sectional view through a piston according to the invention on machining an annular groove by means of a tool according to the invention during a method according to the invention,

FIG. 2 shows a representation as in FIG. 1, but after the roller-burnishing process or respectively after the sliding friction process,

FIG. 3 shows a representation as in FIG. 1, but with a trapezoidal annular groove,

FIG. 4 shows a representation as in FIG. 2, but with the tool removed,

FIG. 5 shows a detailed representation of FIG. 2,

FIG. 6 shows a detailed representation of FIG. 4.

### DETAILED DESCRIPTION

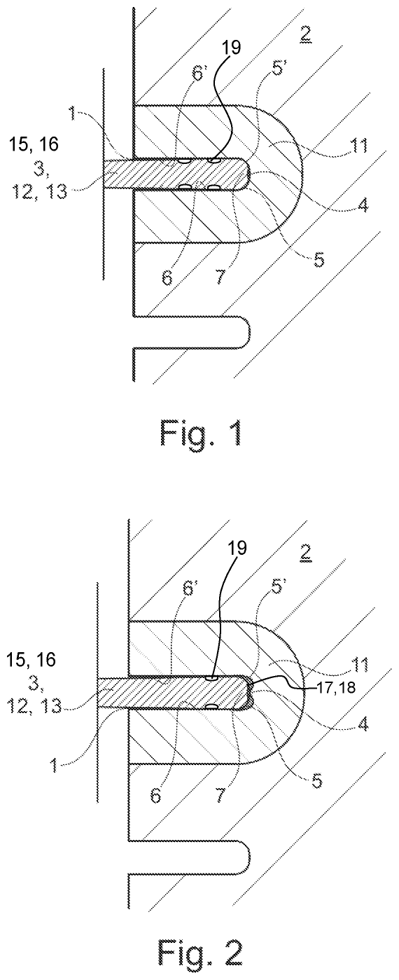

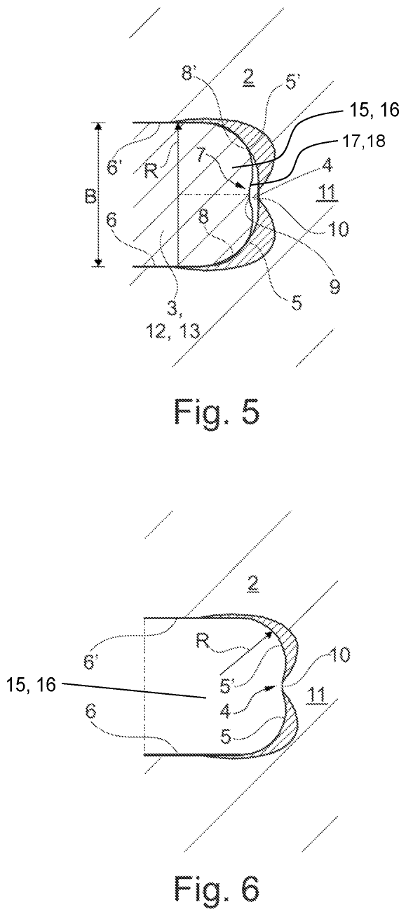

According to FIGS. 1 to 6, in a method according to the invention for machining/producing an annular groove 1 in a piston 2 of an internal combustion engine, which is not designated more closely, a tool 12, in particular a roller-burnishing tool 3 or a sliding friction tool 13, is introduced into the annular groove 1 and is machined with this roller-burnishing toll 3 or with the sliding friction tool 13. In the annular groove 1 in the subsequent operation of the piston 2 in the internal combustion engine, a piston ring is arranged, via which a sealing takes place with respect to a cylinder wall which is not shown. The respective annular groove 1 (cf. in particular FIGS. 4 and 6) has a groove base 4, which transitions in a respective transition region 5, 5′ into lateral groove walls 6, 6′. According to the invention, the at least one annular groove 1, of course also all further annular grooves of the piston 2 can be machined accordingly, is roller-burnished with the roller-burnishing tool 3 or undergoes sliding friction with the sliding friction tool 13, wherein the roller-burnishing tool 3 during roller-burnishing or the sliding friction tool 13 during sliding friction has at its free end 7 in contact with the groove base 4 two lateral convex regions 8, 8′ and a withdrawn region 9 lying therebetween, so that on a roller-burnishing or sliding or respectively generally on a machining with the tool 12 of the annular groove 1, the two transition regions 5, 5′ are reinforced more strongly than a centre region 10 of the groove base 4 (cf. in particular FIGS. 5 and 6).

The roller-burnishing tool 3 or the sliding friction tool 13 has at its free end 7 a bone-shaped or camel's hump-shaped cross-section, whereby the more intensive compressing or respectively smoothing of the two transition regions 5, 5′ can be brought about. Through the roller-burnishing or sliding friction, for example the withdrawn region 9 of the roller-burnishing tool 3 or of the sliding friction tool 13 does not come into contact with the groove base 4, or only with a slight pressure, whereby the centre region 10 of the groove base 4 lying opposite the withdrawn region 9 is not reinforced, compacted or respectively smoothed, or only to a distinctly lesser extent. Through the two convex regions 8, 8′ of the roller-burnishing tool 3 or of the sliding friction tool 13, in addition a transition region 5, 5′ with a comparatively large radius can be created from the groove base 4 to the respective groove lateral walls 6, 6′, whereby the notch effect can be distinctly reduced and hence the load-bearing capacity of the piston 2 can be distinctly increased.

The roller-burnishing tool 3 can have a roller-burnishing wheel 15, formed in one piece, whereby both the convex regions 8, 8′ and also the withdrawn region 9 are formed in one piece. In the same manner, the sliding tool 13 can also have a friction body 16 formed in one piece, whereby likewise both the convex regions 8, 8′ and also the withdrawn region 9 are formed in one piece. Such a sliding tool 13 or respectively roller-burnishing tool 12 can be maintained through an easy exchange of the roller-burnishing wheel 15 or respectively of the friction body 16. In addition, a very economical tool can thus be created.

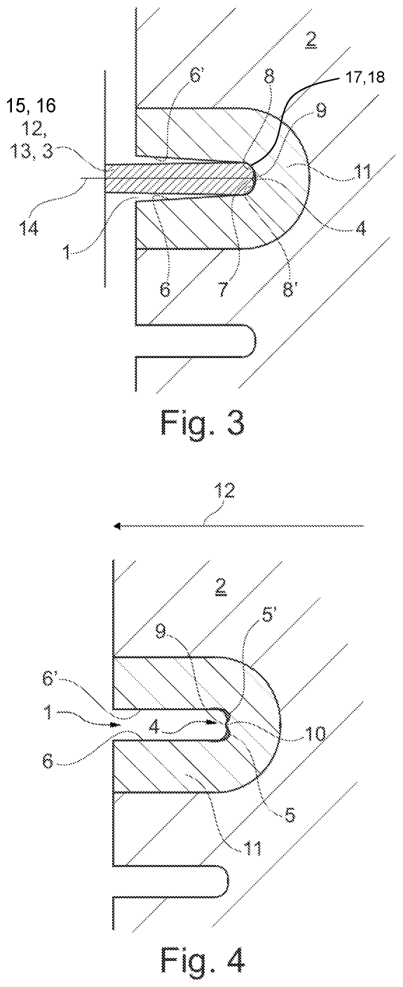

Observing the cross-sectional shape of the tool 12, in particular of the roller-burnishing tool 3 or of the sliding friction tool 13, according to FIG. 2, it can be seen that its cross-section increases towards the free end 7 and narrows in the other direction, i.e. here radially outwards. Hereby, it is possible in particular with rectangular annular grooves 1 to incline or respectively tilt the roller-burnishing tool 3 or the sliding friction tool 13 relative to the radial direction of the piston 2 and thereby to bring about an improved compacting, reinforcing or respectively smoothing of the transition regions 5, 5′. When the annular groove 1 has a trapezoidal cross-section, as is illustrated according to FIG. 3, such an outwardly narrowing shape of the tool 12, in particular of the roller-burnishing tool 3 or of the sliding friction tool 13, with respect to the cross-section, is not absolutely necessary.

The roller-burnishing tool 3 can have on its roller-burnishing wheel 15 a wear protection coating 17, in particular a DLC layer 18. Additionally or alternatively, the sliding tool 13 can have on its friction body 16 a wear protection coating 17, in particular a DLC layer 18. Hereby, a friction and hence a wear on the tool 12 and also undesired deformations on a surface of the workpiece can be reduced.

Again additionally or alternatively, the roller-burnishing wheel 15 and/or the friction body 16 can have on at least one side at least one oil pocket 19 or several such small oil pockets 19, which are drawn enlarged in FIGS. 1 and 2 for better illustration. The plastic deformation of the workpiece through local pressure forces is desired, but not high shear forces on a boundary surface. Through such oil pockets 19 (“dimples” similar to a golf ball), oil can be stored in the roller-burnishing or sliding process, which reduces the (sliding) friction.

The annular groove 1 can generally be arranged in the piston 2 itself or, in accordance with the illustrations according to FIGS. 1 to 6, in a ring carrier 11. Such a ring carrier 11 is usually formed from a ferrous material, for example from steel, and is used in particular in light metal pistons, for example aluminium pistons. A prefabrication of the annular groove 1 can take place for example by a metal-cutting method, for example by turning.

The convex regions 8, 8′ of the tool 12, in particular of the roller-burnishing tool 3 or of the sliding friction tool 13, can have a radius R of R=B/2, wherein B stands for the width or respectively thickness of the tool 12, in particular of the roller-burnishing tool 3 or of the sliding friction tool 13. The withdrawn region 9 can have a bend, for example, or else can be configured in a concave manner, as is illustrated according to FIG. 5. Through the comparatively large radii R and the withdrawn region 9, a reinforced or even exclusive compacting of the transition regions 5, 5′ can take place compared to the centre region 10, wherein the centre region 10 of the groove base 4 of the annular groove 1 is not, or is distinctly less, compacted.

Furthermore, it is conceivable that on roller-burnishing/sliding friction of the annular groove 1, material is displaced from the transition regions 5, 5′ into the centre region 10, so that the groove base 4 in the centre region 10 after the roller-burnishing/sliding friction projects further into the annular groove 1 than before the roller-burnishing/sliding friction. The advantage of the method according to the invention and of the annular groove 1 produced according to the invention is that, owing to the material smoothing and the material reinforcing, in particular in the lower transition region 5 in the case of a combustion chamber lying above in this case, and the comparatively large radii R, a notch effect is reduced or even prevented, in particular on the lower transition region 5 between the groove base 4 and the lower groove wall 6. In tests or respectively calculations, it has been found here that the risk of crack formation through the forces acting on a piston ring in the transition regions 5, especially the lower transition region 5 between the groove flank 6 and the groove base 4, stressed by the combustion gas pressure, is greater than in the centre 7 of the groove base 4 and therefore the maximum application of force and reinforcing is precisely not to take place in the centre region 10 of the groove base 4, as occurs in a tool 12, in particular a roller-burnishing tool 3 or a sliding friction tool 13, with a round free end and a rectangular groove.

The piston 2 according to the invention is also to be included by the invention, in which the annular groove 1 was machined by the method according to the invention, in particular was roller-burnished or underwent sliding friction.

Although the present invention is directed in particular to the annular grooves 1, provided for receiving piston rings, on pistons 2 of internal combustion engines, it is not limited to this application. The machining method according to the invention can also be applied to annular grooves 1 of other pistons 2, such as of compressors for instance. Furthermore, it is generally suitable for the machining of circumferential grooves in circumferential direction on cylindrical circumferential surfaces, preferably outer circumferential surfaces of components, such as for instance of snap ring grooves, e.g. on valve stems, piston pin hubs or camshafts.

Furthermore, the tool 12 according to the invention, in particular the roller-burnishing tool 3 or the sliding friction tool 13, is a component of the present invention, which at its free end 7 has two lateral convex regions 8, 8′ and a withdrawn region 9 lying therebetween. Hereby, an annular groove 1 can be reinforced or respectively smoothed in a corresponding manner and hence increased with regard to a load capacity. The tool 12, in particular the roller-burnishing tool 3 or the sliding friction tool 13, can have a bone-shaped or, in cross-section camel's hump-shaped free end 7 and, in addition, a cross-section can increase towards the free end 7, whereby a tilting of the tool 12, in particular of the roller-burnishing tool 3 or of the sliding friction tool 13, relative to a radial 14 of the piston 2 is possible on machining of the annular groove 1.

The convex regions 8, 8′ of the tool 12, in particular of the roller-burnishing tool 3 or of the sliding friction tool 13, can have here a radius R of R=B/2, wherein additionally or alternatively the withdrawn region 9 of the tool 12, in particular of the roller-burnishing tool 3 or of the sliding friction tool 13, can have a bend or can be configured in a concave manner.

By the method according to the invention, the particularly stressed regions, here the transition regions 5, 5′, can be smoothed and reinforced, and in addition a notch effect can be reduced in these transition regions 5, 5′, whereby the load capacity of the piston 2 according to the invention can be distinctly increased.

1. A method for machining an annular groove, which is circumferential in a circumferential direction, on a cylindrical outer circumferential surface of a component, the annular groove having two lateral groove walls and a groove base transitioning into the two lateral groove walls in a respective transition region of two transition regions, the method comprising:
contacting the groove base with a free end of a tool, the free end including two lateral convex regions and a withdrawn region arranged therebetween; and
reinforcing the annular groove such that the two transition regions of the annular groove are reinforced more strongly than a centre region of the groove base.

2. The method according to claim 1, wherein:
the tool is at least one of a roller-burnishing tool and a sliding friction tool; and
reinforcing the annular groove includes at least one of roller-burnishing and sliding friction of the annular groove such that the two transition regions are reinforced more strongly than the centre region.

3. The method according to claim 2, wherein the free end of the tool has at least one of a bone-shape and a camel's hump-shape.

4. The method according to claim 2, wherein a cross-section of the tool increases towards the free end.

5. The method according to claim 1, wherein one of:
the method further comprises pre-turning the annular groove before reinforcing the annular groove; and
the annular groove is pre-turned before reinforcing the annular groove.

6. The method according to claim 1, wherein the centre region is not reinforced via reinforcing the annular groove.

7. The method according to claim 1, wherein reinforcing the annular groove includes displacing material from the two transition regions into the centre region such that the groove base, in the centre region, projects further into the annular groove than before the annular groove was reinforced.

8. The method according to claim 2, wherein at least one of:
the two convex regions have a radius that is equal to half of a thickness of the tool; and
the withdrawn region at least one of (i) has a bend and (ii) is configured in a concave manner.

9. The method according to claim 2, wherein:
the tool is the roller-burnishing tool;
the roller-burnishing tool includes a monolithic roller-burnishing wheel; and
the two convex regions and the withdrawn region are formed as a single monolithic piece.

10. The method according to claim 2, wherein the tool includes a wear protection coating.

11. The method according to claim 2, wherein the tool includes at least one oil pocket disposed on at least one side.

12. A piston, comprising at least one annular groove for receiving a piston ring, wherein the annular groove is machined according to the method of claim 1.

13. A tool for carrying out the method according to claim 1, the tool comprising a free end including two lateral convex regions and a withdrawn region disposed therebetween.

14. The tool according to claim 13, wherein at least one of:
the free end has at least one of a bone-shape and a camel's hump-shape; and
a cross-section of the tool increases towards the free end.

15. The tool according to claim 13, wherein at least one of:
the two convex regions have a radius that is equal to half of a thickness of the tool; and
the withdrawn region at least one of (i) has a bend and (ii) is configured in a concave manner.

16. The tool according to claim 13, wherein at least one of:
the tool is configured as a roller-burnishing tool including a monolithic roller-burnishing wheel, and the two convex regions and the withdrawn region are formed as a single monolithic piece; and
the tool is configured as a sliding tool including a monolithic friction body, and the two convex regions and the withdrawn region are formed as a single monolithic piece.

17. The tool according to claim 13, wherein at least one of:
the tool is configured as a roller-burnishing tool including a roller-burnishing wheel having a wear protection coating; and
the tool is configured as a sliding tool including a friction body having a wear protection coating.

18. The tool according to claim 13, wherein at least one of:
the tool is configured as a roller-burnishing tool including a roller-burnishing wheel, the roller-burnishing wheel including at least one oil pocket disposed on at least one side; and
the tool is configured as a sliding tool including a friction body, the friction body including at least one oil pocket disposed on at least one side.

19. The method according to claim 2, wherein:
the tool is the sliding tool;
the sliding tool includes a monolithic friction body; and
the two convex regions and the withdrawn region are formed as a single monolithic piece.

20. The method according to claim 10, wherein the wear protection coating includes a DLC layer.
